(19) United States
(12) Patent Application Publication
(10) Pub. No.: US 2021/0194270 A1
(43) Pub. Date: Jun. 24, 2021

(54) Storage Battery Unit, Storage Battery Device and Hybrid-Typed Power Supply System

(71) Applicant: SAVE THE PLANET Co., Ltd., Osaka (JP)

(72) Inventor: Hideaki SOUMA, Osaka (JP)

(21) Appl. No.: 16/995,535

(22) Filed: Aug. 17, 2020

(30) Foreign Application Priority Data
Dec. 24, 2019 (JP) 2019-233455

(51) Int. Cl. H02J 7/34; H02J 3/38; H02M 3/158; H02M 7/5387; H02J 7/00

(52) U.S. Cl. CPC H02J 7/34; H02J 3/381; H02M 3/1584; H02M 2001/007; H02J 7/007; H02J 2300/24; H02M 7/53873

(57) ABSTRACT

A storage battery unit connected to a power conditioner, the storage battery unit includes an enclosure, a storage battery for storing a direct current power, and a DC/DC converter for performing a charging-and-discharging of the storage battery. The enclosure has such a configuration that the enclosure does not include a DC/AC inverter for converting an output from the DC/DC converter to an alternate current power, and that the enclosure has the storage battery and the DC/DC converter.

### CROSS-REFERENCE TO RELATED APPLICATION(S)

This patent application claims priority to JP 2019-233455, filed Dec. 24, 2019, and the entire contents of which are incorporated herein by reference.

### TECHNICAL FIELD

The present invention relates to a storage battery unit connected to a power conditioner, a storage battery device having a plurality of said storage battery units, and a hybrid-typed power supply system having said storage battery device.

### BACKGROUND ART

From the viewpoint of a global environment protection, a development of a dispersed power source system such as a solar cell and fuel cell, which have little effect on the environment, has been actively promoted. In such a distributed power supply system, a DC power generated by the solar cell and the like is converted into an AC power of commercial frequencies by a power conditioner provided with a DC/DC converter and an inverter and the like as a power converter, and the AC power is supplied to loads by being interconnected to a commercial power system, and a surplus power is reversely power-flowed to the commercial power system (For example, see PATENT LITERATURE 1). In addition, in this power supply system, such a system that a storage battery unit is additionally equipped and a generated power is effectively utilized by supplying surplus power thereto (hereinafter referred to as a hybrid-typed power source system) has been also widely known.

At the end of a FIT system in recent years, a new regional application power framework has been groped. In particular, as a countermeasure for securing a power source at the time of disaster, a supply-demand integrated model construction which contributes to a resilience reinforcement is made to be a task, and an effort to stabilize a power source supply is required. Against a background of such a request, in the hybrid-typed power source system, there is a growing need to increase a number of storage battery units in which storage batteries are stored to ensure sufficient utilization time regarding in-house consumption.

As the dispersed power source system associated therewith, the storage battery unit, a three-body-typed system made by connecting three kinds of units, that is, by connecting a bidirectional DCDC converter unit including a bidirectional DC/DC converter for boosting an output voltage from the storage battery unit, and an inverter unit (power conditioner) including an inverter for converting into an AC power for domestic use, has been studied storage battery unit (See PATENT LITERATURE 2).

### CITATION LIST

### Patent Literature

PATENT LITERATURE 1: Japanese Patent Laid-open Publication No. JP2001-161032 A

PATENT LITERATURE 2: Japanese Patent laid-open Publication No. JPH11-163545 A

### SUMMARY OF THE INVENTION

### Technical Problem

However, in the hybrid-typed distributed power source system composed of the three types of units described above, the converter unit and the storage battery unit are physically separated, and therefore, it is necessary to add the two converter units when adding the one storage battery unit. Therefore, in such a hybrid-typed power source system, a layout of each unit is complicated, and an electrical connection work between each of units is complicated and problems on installation structure and construction become remarkable. As a result, there could be a problem of occurring a significant increase in cost.

In addition, it is necessary to electrically connect between each of units using a wiring cable, in the case where a number of units is increased, a number of wiring cables also increases, and therefore, a wiring becomes complicated. As a result, there could be a problem of increasing a risk of miswiring.

Further, in the case where a number of storage battery units increase, each of a length of wiring cables for connecting the power conditioner and each of the storage battery units becomes long, and therefore, there could be a problem of increasing an electrical loss by the wiring and occurring a malfunction due to a noise in the wiring storage battery unit storage battery unit. For example, in the wiring cable, assuming that a resistance is to be 0.1 ohms per one wiring cable and a rated current is to be 50 amperes, a loss of 250 watts occurs each time one wiring cable is added.

In particular, in the case where the wiring cable for electrically connecting between the storage battery unit and the bidirectional DC/DC converter becomes longer, when the storage battery unit performs a discharge operation, an input voltage to the bidirectional DC/DC converter greatly falls to a low level by a voltage drop due to its wiring cable. For this reason, in the case where an efficiency of the bidirectional DC/DC converter drops to a lower level or an discharge current from a battery cell (battery) exceeds an allowable current at the time of discharge (in the case where an overcurrent protective function is activated), in the bidirectional DC/DC converter, there could be such a problem that it is not possible to output an output voltage thereof according to a requirement value and to supply with a power required for the inverter.

The more the number of storage battery units is increased, the more such problems as described above become serious.

An object of the present invention is to solve the above-described problems, and to provide a storage battery unit, a storage battery device, and a hybrid-typed power supply system capable of cutting construction costs and reducing the risk of the miswiring due to simplification of electrical connection works between each of the units.

### Solution to Problem

A storage battery unit according to the present invention is a storage battery unit connected to a power conditioner, and is characterized in that the storage battery unit includes a storage battery for storing a direct current power, a DC/DC converter for converting and outputting a voltage of a direct current power discharged from the storage battery, and does not include a DC/AC inverter for converting the direct current power outputted from the DC/DC converter to an alternate current power.

In the storage battery unit of this invention, since the DC/AC inverter is not included, it is possible to make the storage battery unit more compact and lightweight. Therefore, frontline workers, who extend the storage battery units, can easily attach to and remove from a main storage battery unit.

In another aspect, a storage battery device of the present invention is a storage battery device having a plurality of storage battery units as described above, and is characterized in that the respective DC/DC converters is disposed adjacent to each other.

In the storage battery device of this invention, the storage battery unit for extension can be arranged side by side (articulated) with respect to the main storage battery unit. Similarly, three or more storage battery units for extension can be arranged (articulated) side-by-side with respect to the main storage battery unit. According to this configuration, it is possible to obtain an advantage of simplifying a replacement of storage battery units and an extension work therefor. That is, a layout of each unit can be simpler than that of the conventional hybrid-typed distributed power supply system, and problems on structure and construction do not occur in an electrical connection work between each of units. As a result, it is possible to cut costs significantly.

In addition, in another aspect, a hybrid-typed power supply system having the storage battery device as described above is characterized in that the respective DC/DC converters is connected in series to each other, and that the power conditioner includes the DC/AC inverter for converting an output voltage of the DC/DC converter of the subsequent stage to an alternate voltage.

In the hybrid-typed power supply system of this invention, it is not necessary to connect the power conditioner and the respective storage battery units, respectively, and the bidirectional DC/DC converter within the respective storage battery units can be connected in series to each other, and therefore, it is possible to reduce an electrical loss due to a wiring and to further suppress malfunction due to noise in the wiring.

In addition, it is possible to shorten the wiring cable for electrically connecting between the storage battery unit and the bidirectional DC/DC converter, and therefore, when the storage battery unit performs a discharging operation, an input voltage to the bidirectional DC/DC converter is greatly reduced based on the voltage drop due to its wiring cable, and an discharge current from the storage battery (battery) exceeds an allowable current at the time of discharge of the storage battery (battery), and therefore, an overcurrent protective function is activated. Therefore, it is possible to reduce such a problem that the bidirectional DC/DC converter outputs the output voltage in accordance with the requested value, and to supply the inverter with a required power.

The hybrid-typed power supply system of one embodiment is characterized in that the power conditioner further has a first control portion, and the respective storage battery units further has a second control portion, respectively, and the respective second control portions measures a voltage value of the storage battery of the respective storage battery units to respectively calculate a charge rate (SOC) to respectively transmit to the first control portion, and the first control portion generates a control signal for controlling a charging-and-discharging of the respective storage batteries based on the charge rate (SOC) of the respective storage batteries with respect to the respective second control portions, respectively, so as to have the output voltage of the DC/DC converter of the subsequent stage to be a predetermined voltage.

In this case, “DC/DC converter of the subsequent stage” refers to DC/DC converter disposed at the position closest to the power conditioner, and “DC/DC converter of the previous stage” refers to DC/DC converter disposed at the position furthest to the power conditioner.

In the hybrid-typed power supply system of this one embodiment, the bidirectional DC/DC converter for boosting the output voltage of the storage battery within the storage battery unit is configured to be provided for the respective storage batteries, and therefore, the respective bidirectional DC/DC converters can output an output voltage in accordance with a required value, it is possible to supply the inverter with the required power.

The hybrid-typed power supply system of one embodiment is characterized in that the first control portion communicates with the respective second control portions based on address information indicating a position of the second control portion.

In the hybrid-typed power supply system of this one embodiment, since the first control portion can accurately communicate with the second control portion corresponding to the respective storage batteries, the first control portion can obtain the charge rate of the respective storage batteries. Accordingly, the first control portion can generate the control signal for accurately controlling the charging-and-discharging of the respective storage batteries, and therefore, it is possible to accurately supply the inverter with the required power.

### Advantageous Effects of the Invention

According to the distributed power source system of the present invention, it is possible to cut construction costs and to reduce the risk of the miswiring due to simplification of electrical connection works between each of the units.

### BRIEF DESCRIPTION OF DRAWINGS

FIG. 1 is a block diagram showing components of the hybrid-typed power source system 1 according to an embodiment of the present invention.

FIG. 2 is a perspective view of the storage battery unit 3A of FIG. 1.

### DESCRIPTION OF EMBODIMENTS

Embodiments of the present invention will be described below with reference to the drawings. In the following embodiments, like components are denoted by like reference numerals, and no description is provided for them.

### First Embodiment

In a photovoltaic power system (a distributed power source system), etc. such as a hybrid-typed power source system 1, according to the present embodiment, after an installation of the system, in order to has highly efficient functions of the power source system, it is expected to be hoped for increasing a battery capacity in the hybrid-typed power source system. In this case, it is thought to add storage batteries to an existing hybrid-typed power source system. However, in the case where one or more storage battery units are extended, in order to sufficiently exert a performance (specification) of the storage battery in which the battery capacity and a state of use (SOH (State of Health) indicating a soundness (degradation state) of the storage battery and SOC (States Of Charge) indicating a rate of charge of the storage battery), etc. differ, it is not possible to control all the storage batteries by only one bidirectional DC/DC converter. On the other hand, in the hybrid-typed power source system 1 according to the present embodiment, since it is possible to be individually controlled by the bidirectional DC/DC converter individually provided for each of the storage batteries, it is possible to respectively perform a switching control corresponding to the battery capacity and the state of use of each of the storage batteries (SOH and SOC of a storage battery 33). Therefore, it is possible to sufficiently exhibit the performance (specification) of each of the storage batteries.

In this case, each of voltage values applied to each of the storage batteries 33 included in each of storage battery units 3A, 3B, and 3C respectively differs depending on conditions such as the degree of degradation or the charging rate of each of the storage batteries 33. For example, there is a difference in the degree of degradation of each of the storage batteries 33 occurred by differences such as a number of use, a frequency in use, or an installation environment, and therefore, there is a difference in a charging capacity and a discharging capacity of each of the storage batteries 33 occurred according to the degree of the degradation thereof. Therefore, for example, the voltage value applied to each of the storage batteries 33 differs in a full charging state or an empty state. In this case, SOH is represented by a ratio (%) to an initial full charging capacity of a full charging capacity at the time of degradation. In addition, even if the charging capacity of each of the storage batteries 33 is the same, in the case where an amount of charge is different, the voltage value applied to each of the storage batteries 33 is different. In this case, SOC is represented by a ratio (%) of a current amount of charge to the full charging capacity.

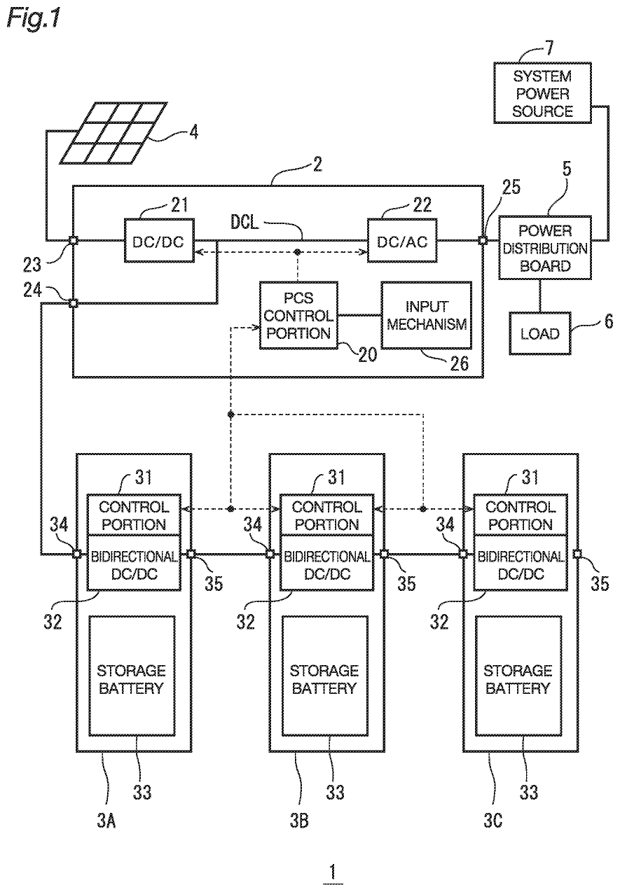

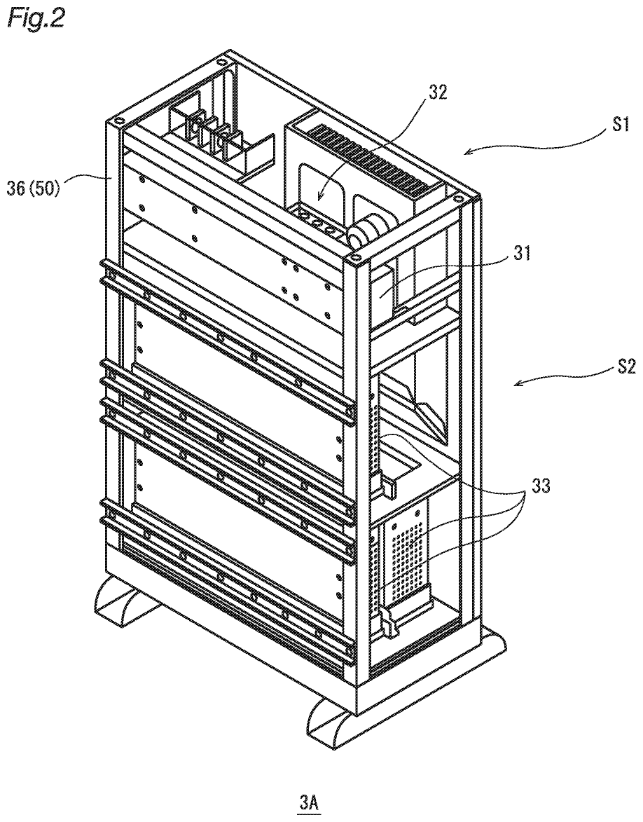

The present embodiment will described as such an example that the storage battery unit 3A is installed as a part of the existing hybrid distributed power source system, and that an installer later wants to add more two storage batteries to the battery capacity, based on this, an operator adds two storage battery units 3B and 3C. It is noted that in the present embodiment as described above, the case where a number of added storage batteries is set to 2 is described, and that the present embodiment is not limited thereto. For example, the number of added storage batteries may be set to a value equal to or more than 2. In addition, the present invention is characterized in that a number of bidirectional DC/DC converters for transforming an output voltage from the storage battery within the storage battery unit is increased with an increase of a number of storage battery units, and that an inverter for converting a DC power from the storage battery within each of the storage battery units into an AC power is not provided within each of the storage battery units, but the only one inverter is provided within another unit and is communalized for an control of each of the bidirectional DC/DC converters. The present invention will be described in detail below with reference to FIG. 1 and FIG. 2.

FIG. 1 is a block diagram showing components of the hybrid-typed power source system 1 according to the embodiment of the present invention. The hybrid-typed power source system 1 of FIG. 1 is configured to include a PV (photovoltaic cell) 4 for converting sunlight into power, a PCS (power conditioner) 2 for controlling so as to supply a load 6 with power, a storage battery unit 3A serving as a main storage battery unit electrically connected via an external terminal 34 with PCS 2, a storage battery units 3B and 3C respectively serving as a storage battery unit for extension connected in series to the storage battery unit 3A, an input mechanism 26 such as a touch panel and an operation button for inputting address information indicating a position of the storage battery unit for extension, and a power distribution board 5 configured to switch on and off an electrical connection between a system power source 7 such as an external commercial power source, and a load 6 such as household equipment and industrial equipment (hereinafter, simply referred to as “load”). In this case, a storage battery device is configured by a plurality of storage battery units 3A, 3B and 3C (hereinafter, the storage battery unit 3A closest to the PCS 2 is referred to as “storage battery unit at a subsequent stage”, and the storage battery unit 3C farthest from the PCS 2 is referred to as “storage battery unit at a preceding stage”). The storage battery device is connected via the PCS 2 to the system power source 7 such as the external commercial power source, and the photovoltaic cell (PV) 4, and a power supplied from the system power source 7 or the PV 4 is stored (charged) in the storage battery units 3A, 3B and 3C. In addition, the power stored in the storage battery units 3A, 3B and 3C is inputted to the power distribution board 5 via an external terminal 25 of the PCS 2 and is supplied to the load 6.

The PCS 2 of FIG. 1 is configured to include a DC/DC converter 21, a DC/AC inverter 22, a DC link line DCL for electrically connecting the DC/DC converter 21 with the DC/AC inverter 22, and a PCS control portion 20 implemented using a hardware such as a microprocessor. In this case, the PCS 2 is an conditioner configured to control so as to charge the storage battery units 3A, 3B and 3C with a power generated electricity by the PV 4 or a power supplied from the system power source 7, respectively, and configured to control so as to supply the load 6 via the power distribution board 5 with the power generated electricity by the PV 4 or a power stored in the storage battery units 3A, 3B and 3C. It is noted that the PCS 2 provides an enclosure for incorporating components such as the DC/DC converter 21, the DC/AC inverter 22, the DC link line DCL, the PCS control portion 20. The following described bidirectional DC/DC converter 32 is not incorporated in this enclosure. Further, the DC/AC inverter 22, which is not incorporated in the following described storage battery units 3A, 3B, and 3C, is arranged in this enclosure. That is, the above DC/AC inverter 22 is incorporated only in the enclosure of the PCS 2 in this power source system 1.

In this case, the PCS control portion 20 acquires information regarding each of the storage batteries 33 from each of control portions 31 of each of the storage battery units 3A, 3B and 3C, and generates a control signal for controlling a switching operation of each of the bidirectional DC/DC converters 32 to transmit to each of the control portions 31. It is noted that the address information indicating the position of the main storage battery unit 3A and the respective address information of the extended and added storage battery units 3B and 3C is inputted via the input mechanism 26 by the installer. This makes the PCS control portion 20 to be capable of communicating with the respective control portions 31 of the storage battery units 3B and 3C and acquiring the address information regarding the respective storage batteries 33. It is noted that although the present embodiment is configured to acquire the address information of the respective storage battery units by means of an manual input of an operator, the present invention is not limited thereto. For example, the present embodiment may be configured to automatically acquire the address information of the respective storage battery units by the PCS control portion 20 at the timing of connecting the extended storage battery unit to the external terminal of the precedent storage battery unit, which is connected with the extended storage battery unit.

As shown in FIG. 1, the PCS2 has the external terminal 23 connected to the DC/DC converter 21, an external terminal 24 connected to the DC link line DCL, and the external terminal 25 connected to the DC/AC inverter 22. In this case, the PV 4 is connected to the DC/DC converter 21 through the external terminal 23, the power distribution board 5 is connected to the DC/AC inverter 22 through the external terminal 25.

In addition, the respective storage battery units 3A, 3B and 3C of FIG. 1 is configured to include the control portion 31, the bidirectional DC/DC converter 32, the storage battery 33 which is power storage means for storing a power (energy), and the external terminals 34 and 35 electrically connected to the bidirectional DC/DC converter 32, respectively. In this case, the respective storage battery units 3A, 3B and 3C does not include an inverter, respectively, and the DC/AC inverter 22 of the PCS 2 converts to an AC power of commercial frequencies to supply to the load 6 by interconnecting with the system power source 7 and to reversely power-flow to the system power source 7. It is noted that a variety of storage batteries such as a lead storage battery, a lithium ion battery, or a lithium ion capacitor are available as the power storage means.

As described above, since the respective storage battery units 3A, 3B and 3C does not include the DC/AC inverter 22, respectively, it is possible to make the storage battery unit more compact and lightweight. Therefore, frontline workers, who extend the storage battery units, can easily attach to and remove from the main storage battery unit 3A.

As shown in FIG. 1, the external terminal 34 of the main storage battery unit 3A is connected to the DC link line DCL via the external terminal 24 of the PCS 2. In addition, the external terminal 34 of the storage battery unit 3B for extension is connected to the external terminal 35 of the main storage battery unit 3A, and the external terminal 34 of the storage battery unit 3C for extension is connected to the external terminal 35 of the storage battery unit 3B for extension. The respective storage battery units 3A, 3B and 3C forms a converter group by connecting in series to each other. As described above, by allowing the extension in series to the main storage battery unit 3A, it is possible to easily and inexpensively increase a capacity of the storage battery without losing a convenience of a user. In this case, being capable of extending the storage battery unit means that the frontline workers, who install the storage battery units, can attach to and remove from the main storage battery unit 3A without requiring special tools, and can be arbitrarily changed a number of storage battery units attached thereto. It is noted that although the case where a number of storage battery units for extension is set to 2 is described in the present embodiment, the number of storage battery units for extension may be set to a value equal to one or a value equal to or more than 3.

In this case, the bidirectional DC/DC converter 32 and the storage battery 33 of the respective storage battery units 3A, 3B and 3C are electrically connected to each other, and the respective control portions 31 controls a charging-and-discharging with respect to the respective storage batteries 33. That is, the bidirectional DC/DC converter 32 is electrically connected between the storage battery 33 and the DC link line DCL.

The DC/DC converter 21 boosts a voltage of a direct current power-generated by the PV 4, and outputs to the DC link line DCL as a direct current power of a high voltage. In addition, the DC/AC inverter 22 converts a direct current voltage inputted from the DC link line DCL to an alternate current voltage to output to the load 6 or the system power source 7 via the distribution board 5. That is, the DC/AC inverter 22 converts an output voltage from the bidirectional DC/DC converter 32, which is located at one end of the aforementioned converter group, to an alternate current voltage.

In addition, the bidirectional DC/DC converter 32 included in the respective storage battery units 33 is electrically connected to the control portion 31 for controlling the bidirectional DC/DC converter 32 based on a control signal from the PCS control portion 20. In this case, the control portion 31 is realized using a hardware such as a microprocessor.

The bidirectional DC/DC converter 32 of the storage battery unit 3A boosts a direct current voltage inputted from the DC link line DCL to output to the storage battery 33. In addition, the bidirectional DC/DC converter 32 of the storage battery unit 3B boosts a direct current voltage inputted from the DC link line DCL to output to the storage battery 33. Further, the bidirectional DC/DC converter 32 of the storage battery unit 3C boosts a direct current voltage inputted from the DC link line DCL to output to the storage battery 33.

The bidirectional DC/DC converter 32 of the storage battery unit 3A boosts a direct current voltage inputted from the storage battery 33 to output to the DC link line DCL. In addition, the bidirectional DC/DC converter 32 of the storage battery unit 3B boosts a direct current voltage inputted from the storage battery 33 to output to the DC link line DCL. Further, the bidirectional DC/DC converter 32 of the storage battery unit 3C boosts a direct current voltage inputted from the storage battery 33 to output to the DC link line DCL.

The control portion 31 is a control device for communicating with the PCS control portion 20, which is realized by a CPU and a program stored in a memory device (not shown) realized by a ROM, a RAM, a HDD, a flash memory and the like. In addition, the control portion 31 includes a wire or wireless communication interface for communicating with the PCS control portion 20.

In addition, the control portion 31 acquires information indicating each of states of the respective storage batteries 33 of the respective storage battery units 3A, 3B and 3C to transmit to the PCS control portion 20. In this case, the information indicating each of states of the respective storage batteries 33 includes charging information (charging signal) regarding the SOH (State of Health) indicating the soundness of the storage battery and SOC (States Of Charge) indicating the rate of charge of the respective storage batteries 33.

The PCS control portion 20 is a control device for communicating with the control portion 31, which is realized by a CPU and a program stored in a memory device (not shown) realized by a ROM, a RAM, a HDD, a flash memory and the like. In addition, the PCS control portion 20 acquires information retained by the respective control portions 31 based on the address information of the respective storage battery units 3B and 3C inputted via the input mechanism 26 by an operator. In this case, the PCS control portion 20 provides a wire or wireless communication interface for communicating with the control portion 31 of the respective storage battery units 3A, 3B and 3C.

In addition, the PCS control portion 20 respectively generates a control signal for instructing a switching operation of the bidirectional DC/DC converter 32 of the respective storage battery units 3A, 3B and 3C based on SOC or SOH indicating the respective states (battery states) of the respective storage batteries 33 acquired from the respective control portions 31 to transmit to the respective control portions 31. That is, the PCS control portion 20 controls a switching operation of the bidirectional DC/DC converter 32 of the respective storage battery units 3A, 3B and 3C so that a direct current power transformed (converted) to a predetermined voltage flows through the DC link line DCL.

FIG. 2 is a perspective view of the storage battery unit 3A of FIG. 1. The storage battery unit 3A of FIG. 2 is configured by storing the control portion 31, the bidirectional DC/DC converter 32 and the storage battery 33 within a storing panel, which consists of a rectangular parallelepiped enclosure 36 having an opening portion formed at the front thereof and a lid body (not shown) attached to the enclosure 36 so as to cover the opening portion. In this case, the enclosure 36 is configured by combining a plurality of holding members so as to constitute a first storing space S1 for storing the control portion 31 and the bidirectional DC/DC converter 32 and a second storing space S2 for storing the storage battery 33. In addition, this enclosure 36 is configured not to include the DC/AC inverter 22 as described above, and has the storage battery 33 and the bidirectional DC/DC converter 32. It is noted that a number of cells composing the storage battery 33 is set to be three in the present embodiment, but the number of cells may be set to be numerical value other than three. It is noted that the respective storage battery units 3B and 3C has the same configuration as that of the storage battery unit 3A. In the respective storage battery units 3A, 3B and 3C, the storage battery unit 3A is not arranged in the first storing space S1. Instead, the control portion 31, the bidirectional DC/DC converter 32, a power source circuit, external connection connectors connected to the power source circuit, and the like are housed in the first storing space S1. It is noted that a long-sized heat sink is provided over a space of the first storing space S1 to the second storing space S2 in the present embodiment. Components (a power transistor, a reactor, and the like) of the above-described bidirectional DC/DC converter 32 are appropriately deployed in this heat sink. This component is appropriately positioned in a place where it is favorable for heat exchange.

By the way, as illustrated in FIG. 1, the storage battery units 3A, 3B and 3C of the present embodiment can respectively be disposed adjacent to each other by connecting the external terminal 34 of the bidirectional DC/DC converter 32 and the external terminal 35 of the bidirectional DC/DC converter 32. Therefore, the storage battery units 3B and 3C for extension can be arranged side by side (articulated) with respect to the main storage battery unit 3A. Similarly, three or more storage battery units for extension can be arranged (articulated) side-by-side with respect to the main storage battery unit 3A. According to this configuration, it is possible to obtain an advantage of simplifying a replacement of storage battery units and an extension work therefor.

The operation of the hybrid-typed power source system 1 configured as above will be described below. In this case, the hybrid-typed power source system 1 is controlled by the PCS control portion 20 and the respective control portions 31 of the storage battery units 3A, 3B and 3C.

First of all, the operation operated by the hybrid-typed power source system 1 until the PCS control portion 20 recognizes a state of the respective storage batteries 33 stored in the storage battery units 3A, 3B and 3C connected to each other will be described below. In this case, each of address information, which is set to each of the control portion 31 of the respective storage battery units 3A, 3B and 3C, is inputted via the input mechanism 26 by the operator. Thus, the PCS control portion 20 can communicate with the respective control portions 31, and can recognize the address information regarding which storage battery unit among the storage battery units 3A, 3B and 3C, and can accurately recognize the state of the storage battery 33 stored respectively in the respective storage battery units 3A, 3B and 3C.

The respective control portions 31 of the respective storage battery units 3A, 3B and 3C measures a voltage value of the respective storage batteries 33 to calculate the SOC, and notifies the calculated SOC to the PCS control portion 20. The PCS control portion 20 respectively generates the control signal for controlling the switching operation of the respective bidirectional DC/DC converters 32, which controls a discharging-and-charging of the respective storage batteries 33, based on the SOC acquired from the respective control portions 31, and transmits to the respective control portions 31. In this case, the PCS control portion 20 controls the discharging-and-charging of the respective storage batteries 33 by controlling the switching operation of the respective bidirectional DC/DC converters 32 so that the output voltage of the bidirectional DC/DC converter 3A of the subsequent stage (one end of the converter group) reaches to a predetermined voltage, that is, so that a DC current having a predetermined voltage flows through the DC link line DCL.

It is noted that an acceptable range of the SOC may be predefined or may be configured to be determined by operating (inputting) via the input mechanism 26 by the operator. In this case, the PCS control portion 20 may be configured to stop the charging-and-discharging of the respective storage batteries 33 by controlling the switching operation of the respective bidirectional DC/DC converters 32 in the case where the SOC acquired from the respective control portions 31 is deviated from the predefined acceptable range of the SOC.

In addition, the respective control portions 31 may be configured to perform a notification indicating such a state that the storage battery 33 is fully charged, a notification indicating such a state that the storage battery 33 is fully discharged, or a notification for requesting to stop the charging-and-discharging of the storage battery 33. The PCS control portion 20 may be configured to control the charging-and-discharging of the respective storage batteries 33 based on the above-described notifications.

Further, the respective control portions 31 monitors an abnormal of the respective storage battery units 3A,3B and 3C, respectively. For example, the respective control portions 31 may be configured to perform an notification for requesting to stop the charging-and-discharging of the storage battery 33 by controlling the switching operation of the respective bidirectional DC/DC converters 32 with respect to the PCS control portion 20 in the case where the respective control portions 20 detects an over-charge, over-discharge, or the like of the storage battery 33.

The operating procedure of the hybrid-typed power source system 1 according to the present embodiment will be described as follow.

Firstly, the respective storage battery units 3A, 3B and 3C may be activated (step S101). For example, the respective storage battery units 3A, 3B and 3C may be configured to be activated by operating the input mechanism 26 of the PCS 2 by the operator, and may be activated at a given time using a real-time clock or the like for counting a time.

Next, the respective control portions 31 judges whether or not the state of the respective storage batteries 33 is detected (step S102), in the case where a predetermined state is detected, the operation of step S102 is repeated.

On the other hand, the respective control portions 31 judges whether or not the state of the respective storage batteries 33 is detected, in the case where a predetermined state is detected, the respective control portions 31 notifies (transmits) a value of the SOC for indicating the state of the respective storage batteries 33 to the PCS control portion 20 (step S103).

Next, the PCS control portion 20 generates control signals S1, S2 and S3 for controlling the switching operation of the respective bidirectional DC/DC converters 32 for controlling the charging-and-discharging of the respective storage batteries 33 based on the SOC acquired from the respective control portions 31, and transmits the control signals S1, S2 and S3 to the respective control portions 31, respectively (step S104). Next, in step S105, the control portion 31 of the storage battery unit 3A calculates a boosting ratio of the bidirectional DC/DC converter 34 based on the control signal S1, and controls the switching operation of the bidirectional DC/DC converter 34 based on the calculated boosting ratio. Similarly, the switching operation of the bidirectional DC/DC converter of the respective storage battery units 3B and 3C is also controlled based on the control signals S2 and S3, respectively. Thus, the PCS control portion 20 supplies the load 6 with a power via the distribution board 5 while controlling the charging-and-discharging of the respective storage batteries 33, by controlling the switching operation of the respective bidirectional DC/DC converters 32 so that a direct current having a predetermined voltage flows in the DC link line DCL.

According to the present embodiment as described above, as compared with the conventional hybrid-typed distributed power supply system composed of three units, it is sufficient to add only one unit when one storage battery unit is added, and therefore, a layout of each unit can be simpler than that of the conventional hybrid-typed distributed power supply system, and problems on structure and construction do not occur in an electrical connection work between each of units. As a result, it is possible to cut costs significantly.

In addition, a number of wiring cables for electrically connecting between each of units can also be reduced, and therefore, it is possible to simplify a wiring work, and to further reduce a risk of miswiring by the operator.

In addition, when connecting a plurality of storage battery units, the state of the storage battery in the respective storage battery units is different to each other, it is impossible to control so as to have the output voltage to be a predetermined voltage in one bidirectional DC/DC converter. In contrast, according to the distributed power supply system of the present embodiment, the bidirectional DC/DC converter for transforming the output voltage of the storage battery within the storage battery unit is configured to be provided for the respective storage batteries, and therefore, the respective bidirectional DC/DC converters can output an output voltage in accordance with a required value, it is possible to supply the inverter with a required power.

Further, it is not necessary to connect the power conditioner and the respective storage battery units, respectively, and the bidirectional DC/DC converter within the respective storage battery units can be connected in series to each other, and therefore, it is possible to reduce an electrical loss due to a wiring and to further suppress malfunction due to noise in the wiring.

In particular, in the hybrid-typed power supply system according to the present embodiment, it is possible to shorten the wiring cable for electrically connecting between the storage battery unit and the bidirectional DC/DC converter, and therefore, when the storage battery unit performs a discharging operation, an input voltage to the bidirectional DC/DC converter is greatly reduced based on the voltage drop due to its wiring cable, and an discharge current from the storage battery (battery) exceeds an allowable current at the time of discharge of the storage battery (battery), and therefore, an overcurrent protective function is activated. Therefore, it is possible to reduce such a problem that the bidirectional DC/DC converter outputs the output voltage in accordance with the requested value, and to supply the inverter with the required power.

Furthermore, in the hybrid-typed power supply system according to the present embodiment, the inverter for converting a DC power from the storage battery within each of the storage battery units into an AC power is not provided within each of the storage battery units, but the only one inverter is provided within another unit and is communalized for the control of each of the bidirectional DC/DC converters. Therefore, it is not necessary to provide the inverter in each storage battery unit. Accordingly, it is possible to make the storage battery unit more compact and lightweight, and frontline workers, who extend the storage battery units, can easily attach to and remove from the main storage battery unit 3A.

While embodiments of the present invention have been described, the above embodiments have been presented by way of example and are not intended to limit the scope of the present invention. These novel embodiments can be embodied in a variety of other embodiments, and a variety of omissions, replacements, and changes can be made to the extent that they do not deviate from the subject-matter of the present invention. These embodiments and their deformations are included in the scope and abstract of the invention, as well as within the scope of the present invention as defined by the appended claims and the equivalents thereof.

### REFERENCE SIGNS LIST

1 Hybrid-typed power source system,
2 Power conditioner,
3A, 3B and 3C Storage battery unit,
4 Photovoltaic cell,
5 Power distribution board,
6 Load, and
7 System power source.

1. A storage battery unit connected to a power conditioner, the storage battery unit comprising:
an enclosure;
a storage battery for storing a direct current power, and
a DC/DC converter for performing a charging-and-discharging of the storage battery,
wherein the enclosure has such a configuration that the enclosure does not include a DC/AC inverter for converting an output from the DC/DC converter to an alternate current power, and that the enclosure has the storage battery and the DC/DC converter.

2. A storage battery device having a plurality of storage battery units as claimed in claim 1,
wherein the respective DC/DC converters is disposed adjacent to each other, respectively.

3. A hybrid-typed power supply system having the storage battery device as claimed in claim 2,
wherein the respective DC/DC converters forms a converter group by connecting in series to each other,
wherein the power conditioner includes the DC/AC inverter for converting an output voltage from the DC/DC converter located at one end of the converter group to an alternate voltage.

4. The hybrid-typed power supply system as claimed in claim 3,
wherein the power conditioner has a first control portion,
wherein the respective storage battery units has a second control portion, respectively,
wherein the respective second control portions measures a voltage value of the storage battery of the respective storage battery units to calculate a charge rate, respectively, and transmits as a charging information or a charging signal indicating the charge rate to the first control portion, respectively, and
wherein the first control portion generates a control signal for controlling a discharge of the respective storage batteries based on the received charging information or the received charging signal with respect to the respective second control portions, respectively, so as to have the output voltage of the DC/DC converter located at one end of the converter group to be a predetermined voltage.

5. The hybrid-typed power supply system as claimed in claim 4,
wherein the first control portion communicates with the respective second control portions based on address information set in each of the second control portions.
